(19) United States
(12) Patent Application Publication
(10) Pub. No.: US 2026/0018737 A1
(43) Pub. Date: Jan. 15, 2026

(54) POWER STORAGE DEVICE

(71) Applicant: TOYOTA JIDOSHA KABUSHIKI KAISHA, Toyota-shi (JP)

(72) Inventors: Akio UOTANI, Nagoya-shi (JP); Dexu ZHANG, Mishima-shi (JP); Yoshinobu KUROYAMA, Aichi-ken (JP); Daisuke KAMESAKI, Okazaki-shi (JP); Seigo FUJISHIMA, Miyoshi-shi (JP); Yuki TAKAHASHI, Miyoshi-shi (JP)

(73) Assignee: TOYOTA JIDOSHA KABUSHIKI KAISHA, Toyota-shi (JP)

(21) Appl. No.: 19/044,798

(22) Filed: Feb. 4, 2025

(30) Foreign Application Priority Data
Jul. 12, 2024 (JP) 2024-112258

(51) Int. Cl. H01M 50/367; H01M 50/209

(52) U.S. Cl. CPC H01M 50/367; H01M 50/209; H01M 2200/20

(57) ABSTRACT

The first power storage module and the second power storage module are disposed in the housing case in the Y direction. A first space is formed between the first power storage module and the second power storage module and the first side wall portion in the +X direction. A second space is formed between the first power storage module and the second power storage module and the first side wall portion in the −X direction. The third side wall portion and the fourth side wall portion in the Y direction are provided with a case exhaust valve for discharging the gas discharged from the power storage cell to the outside of the housing case.

### CROSS-REFERENCE TO RELATED APPLICATION

This application claims priority to Japanese Patent Application No. 2024-112258 filed on Jul. 12, 2024, incorporated herein by reference in its entirety.

### BACKGROUND

### 1. Technical Field

The present disclosure relates to a power storage device.

### 2. Description of Related Art

Japanese Unexamined Patent Application Publication (Translation of PCT Application) No. 2022-516519 (JP 2022-516519 A) discloses a battery pack in which part of a housing case that houses single cells is formed from a hollow member and a hollow portion of the hollow member is used as an exhaust passage (gas passage). A plurality of intake holes is formed in the hollow member constituting the housing case to introduce gas discharged from the single cells.

### SUMMARY

In JP 2022-516519 A, the intake hole faces an explosion-proof valve (exhaust valve, safety valve) for the single cell, and is disposed in a one-to-one correspondence. Gas discharged from the explosion-proof valve for the single cell flows into the exhaust passage via the corresponding intake hole. In the configuration of JP 2022-516519 A, machining for forming the intake holes corresponding to the number of single cells is necessary, and the manufacturing cost increases.

An object of the present disclosure is to discharge, to the outside of a case that houses a power storage cell, gas discharged from the power storage cell without forming many intake holes in the case.

A power storage device of the present disclosure includes:
a first power storage module including a plurality of first power storage cells;
a second power storage module including a plurality of second power storage cells; and
a housing case that houses the first power storage module and the second power storage module.

The first power storage module and the second power storage module are disposed in a first direction.

The housing case includes a first side wall portion located on one side in a second direction orthogonal to the first direction, and a second side wall portion located on the other side in the second direction.

A first space is defined between each of the first power storage module and the second power storage module and the first side wall portion.

A second space is defined between each of the first power storage module and the second power storage module and the second side wall portion.

The housing case includes a case exhaust valve that discharges gas discharged from at least one of the first power storage cells and the second power storage cells to an outside of the housing case.

In this configuration, the first power storage module and the second power storage module are disposed in the first direction and housed in the housing case. The housing case includes the first side wall portion and the second side wall portion. The first side wall portion is located on the one side in the second direction orthogonal to the first direction, and the second side wall portion is located on the other side in the second direction. The first space is defined between each of the first power storage module and the second power storage module and the first side wall portion. The second space is defined between each of the first power storage module and the second power storage module and the second side wall portion. The housing case includes the case exhaust valve, and the gas discharged from the power storage cell is discharged to the outside of the housing case via the case exhaust valve. The gas discharged from the power storage cell can be discharged to the outside of the housing case through the first space and the second space. The gas discharged from the power storage cell can be discharged to the outside of the housing case without forming many intake holes in the housing case.

Preferably, the housing case further includes a third side wall portion located on one side in the first direction, and a fourth side wall portion located on the other side in the first direction.

The case exhaust valve includes a first case exhaust valve and a second case exhaust valve provided in the third side wall portion at positions where the first case exhaust valve and the second case exhaust valve face the first space and the second space, respectively.

The case exhaust valve includes a third case exhaust valve and a fourth case exhaust valve provided in the fourth side wall portion at positions where the third case exhaust valve and the fourth case exhaust valve face the first space and the second space, respectively.

In this configuration, the case exhaust valves are provided at the positions where the case exhaust valves face the first space and the second space. Therefore, the gas can be discharged efficiently.

Preferably, the first power storage cells are arranged in the second direction.

The second power storage cells are arranged in the second direction.

At least one of the first power storage cells includes an exhaust valve that discharges gas toward the second power storage module.

At least one of the second power storage cells includes an exhaust valve that discharges gas toward the first power storage module.

First guide members that guide the gas from a central side in the first direction toward the first case exhaust valve and the third case exhaust valve are disposed in the first space to adjoin the first power storage module and the second power storage module.

Second guide members that guide the gas from the central side in the first direction toward the second case exhaust valve and the fourth case exhaust valve are disposed in the second space to adjoin the first power storage module and the second power storage module.

In this configuration, the gas discharged from the power storage cell can be guided to the case exhaust valve by the guide member. Therefore, stagnation of the gas can be suppressed.

According to the present disclosure, it is possible to discharge, to the outside of the case that houses the power storage cell, the gas discharged from the power storage cell without forming many intake holes in the case.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a power storage device according to an embodiment of the present disclosure;

FIG. 2 is a plan view of a power storage device;

FIG. 3 is a plan view of a power storage device according to Embodiment 2;

FIG. 4 is a plan view of a power storage device according to Embodiment 3;

FIG. 5 is a plan view of a power storage device according to Embodiment 4; and

FIG. 6 is a plan view of a power storage device according to Embodiment 5.

### DETAILED DESCRIPTION OF EMBODIMENTS

Embodiments of the present disclosure will be described in detail with reference to the drawings. In the drawings, the same or corresponding parts are denoted by the same reference numerals, and the description thereof will not be repeated. In the drawings used below, “+” is indicated in the directions indicated by arrows of the X axis, the Y axis, and the Z axis in the X axis, the Y axis, and the Z axis orthogonal to each other, and “−” is indicated in the opposite direction. Dimensional relationships (length, width, thickness, etc.) in the drawings do not reflect actual dimensional relationships.

### First Embodiment

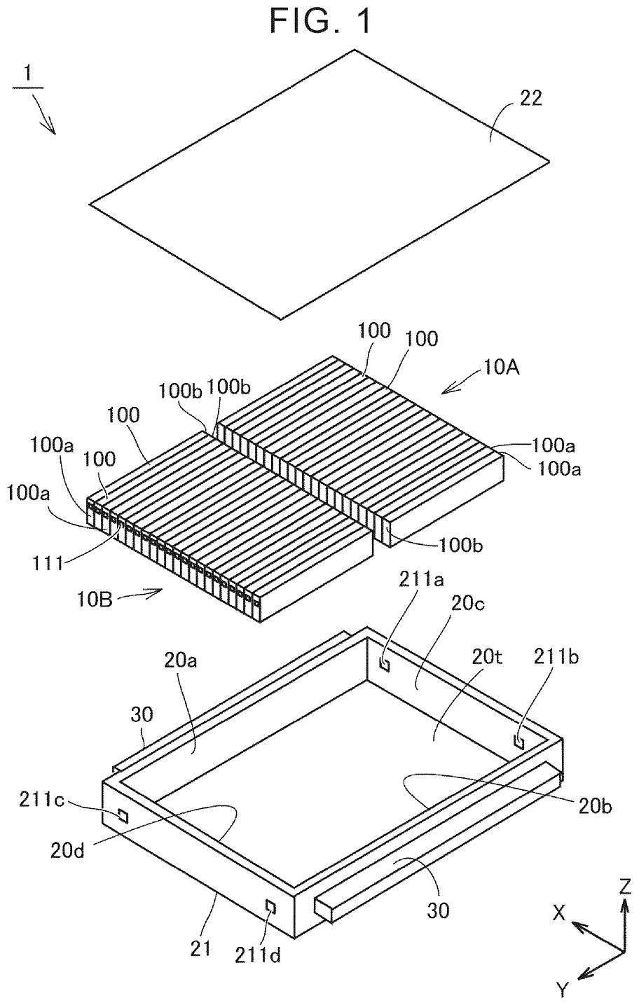

FIG. 1 is an exploded perspective view of a power storage device 1 according to an embodiment of the present disclosure. The power storage device 1 is, for example, a power storage device mounted on a battery electric vehicle (BEV) that does not include an internal combustion engine. However, the present disclosure is not limited thereto, and the power storage device 1 may be mounted on a plug-in hybrid electric vehicle (PHEV) including an internal combustion engine, or may be mounted on another electrified vehicle (xEV).

The power storage device 1 includes a plurality of power storage modules 10 (a first power storage module 10A and a second power storage module 10B), and a housing case 20 that houses the power storage module 10. The first power storage module 10A and the second power storage module 10B have the same configuration and include a plurality of power storage cells 100.

The housing case 20 of the power storage device 1 includes a LWR (lower) case 21 and a UPR (upper) case 22. LWR case 21 includes a plate-shaped bottom 21t and a plurality of side wall portions 20a to 20d. The first side wall portion 20a is disposed on the +X side, and the second side wall portion 20b is disposed on −X side. The third side wall portion 20c is disposed on −Y side, and the fourth side wall portion 20d is disposed on the +Y side.

The first power storage module 10A and the second power storage module 10B are disposed adjacent to each other in the Y direction. The Y direction corresponds to the “first direction” of the present disclosure. The power storage cells 100 included in the first power storage module 10A are arranged in the X direction. The power storage cells 100 included in the second power storage module 10B are arranged in the X direction. The X direction corresponds to the “second direction” of the present disclosure.

UPR case 22 functions as a cover for LWR case 21. After the first power storage module 10A and the second power storage module 10B are fixed to the bottom 21t of LWR case 21, UPR case 22 is attached to LWR case 21. Thus, the first power storage module 10A and the second power storage module 10B are housed in the housing case 20.

The third side wall portion 20c and the fourth side wall portion 20d of LWR case 21 are provided with a plurality of case exhaust valves 211 (211a to 211d). The case exhaust valve 211 is opened when the pressure inside the housing case 20 exceeds a predetermined pressure. The case exhaust valve 211 discharges the gas discharged from the power storage cell 100 to the outside of the housing case 20.

Mounting brackets 30 are fixed to LWR case 21. The housing case 20 is fixed to, for example, the floor of the vehicle by the mounting bracket 30.

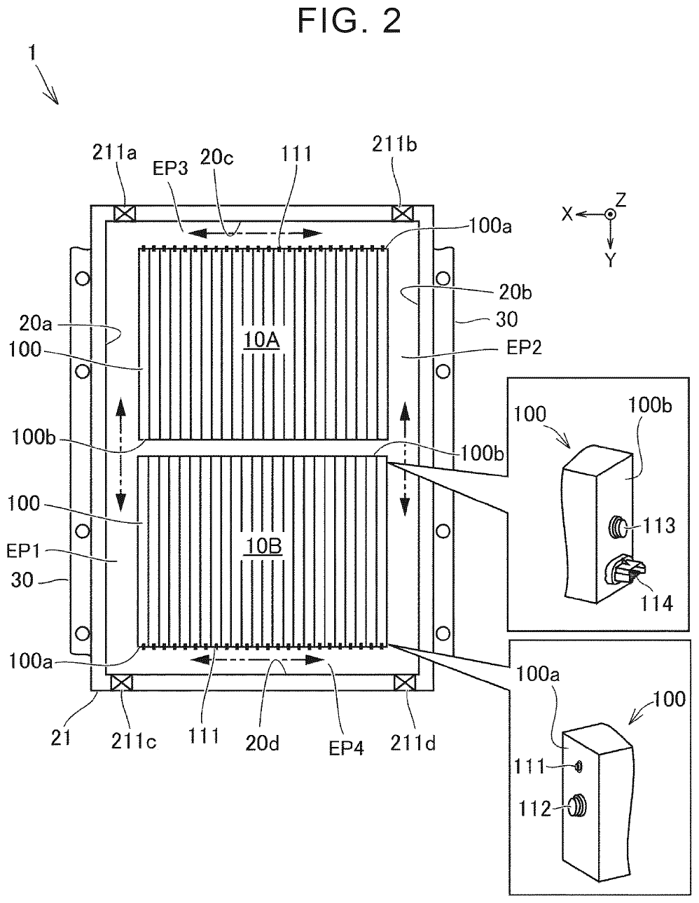

FIG. 2 is a plan view of the power storage device 1. In FIG. 2, UPR case 22 is omitted. For example, the power storage cell 100 is fixed to the bottom 21t of LWR case 21 by adhesion. By arranging the plurality of power storage cells 100 in the X direction, the first power storage module 10A is configured. The power storage cell 100 included in the first power storage module 10A corresponds to the “first plurality of power storage cells” of the present disclosure. By arranging the plurality of power storage cells 100 in the X direction, the second power storage module 10B is configured. The power storage cell 100 included in the second power storage module 10B corresponds to a “second plurality of power storage cells” of the present disclosure. The first power storage module 10A and the second power storage module 10B are disposed adjacent to each other in the Y direction.

The first power storage module 10A and the second power storage module 10B have a configuration in which a plurality of power storage cells 100 are stacked in the X direction. An electrode body is housed in a case of the power storage cell 100. The electrode body is, for example, a wound body in which a positive electrode sheet and a negative electrode sheet are wound with a separator interposed therebetween. For example, one or more windings functioning as electrode bodies may be housed in a metallic square case covered by a laminate casing. The electrode body may be a laminate in which a positive electrode sheet and a negative electrode sheet are laminated with a separator interposed therebetween. Each of the positive electrode sheet and the negative electrode sheet includes an electrode foil and an active material layer. The power storage cell 100 is, for example, a secondary battery such as a lithium ion battery, a nickel metal hydride battery, or a sodium ion battery. Examples of the lithium-ion battery include a LFP cell in which lithium iron phosphate is employed as a positive electrode active material, or a ternary cell in which NMC (nickel-manganese-cobalt) is employed as a positive electrode active material. The type of the secondary battery may be a liquid secondary battery or a solid secondary battery.

The power storage cell 100 has a rectangular parallelepiped shape whose longitudinal direction is the Y direction. The ratio of the length (the dimension in the Y direction) to the width (the dimension in the X direction) of the power storage cell 100 may be 4 or more and 25 or less. The widths and lengths of the power storage cells 100 may be about 50 mm and about 1000 mm, respectively. The height (dimension in the Z direction) of the power storage cell 100 is equal to or less than the height of 20d from the plurality of side wall portions 20a. The height of the power storage cell 100 may be about 100 mm.

The power storage cell 100 has a first end face 100a and a second end face 100b in the longitudinal direction (Y direction). The first end face 100a includes an exhaust valve 111. The exhaust valve 111 opens when the internal pressure of the power storage cell 100 exceeds a predetermined pressure, and discharges the gas in the power storage cell 100 to the outside of the power storage cell 100. In the first power storage module 10A, the power storage cells 100 are arranged such that the first end face 100a faces −Y side and the second end face 100b faces the +Y side. In the second power storage module 10B, the power storage cells 100 are arranged such that the first end face 100a faces the +Y side and the second end face 100b faces −Y side.

On the first end face 100a of the power storage cell 100, an external terminal 112 is provided in addition to the exhaust valve 111. An external terminal 113 and a connector 114 are provided on the second end face 100b of the power storage cell 100. In the present embodiment, the external terminal 112 may be a positive terminal, and the external terminal 113 may be a negative terminal. The connector 114 includes an output terminal that outputs a detection signal indicating a state of the power storage cell 100 (for example, an internal temperature of the power storage cell 100) to the outside.

In the first power storage module 10A and the second power storage module 10B, the external terminals 112 of the adjacent power storage cells 100 are connected by a bus bar, and the external terminals 113 of the adjacent power storage cells 100 are connected by a bus bar. In the present embodiment, in the first power storage module 10A and the second power storage module 10B, a plurality of power storage cells 100 are electrically connected in parallel.

In the first power storage module 10A, the first end face 100a of the power storage cell 100 is disposed to face the third side wall portion 20c. A third space EP3 is formed between the first end face 100a (first power storage module 10A) of the power storage cell 100 and the third side wall portion 20c. In the second power storage module 10B, the first end face 100a of the power storage cell 100 is disposed to face the fourth side wall portion 20d. A fourth space EP4 is formed between the first end face 100a (the second power storage module 10B) of the power storage cell 100 and the fourth side wall portion 20d. The exhaust valve 111 of the power storage cell 100 included in the first power storage module 10A faces the third space EP3. The exhaust valve 111 of the power storage cell 100 included in the second power storage module 10B faces the fourth space EP4. The third space EP3 is a gap between the first power storage module 10A and the third side wall portion 20c. The fourth space EP4 is a gap between the second power storage module 10B and the fourth side wall portion 20d.

A first space EP1 is formed between the first side wall portion 20a of LWR case 21 and the first power storage module 10A and between the first side wall portion 20a and the second power storage module 10B. A second space EP2 is formed between the second side wall portion 20b of LWR case 21 and the first power storage module 10A and between the second side wall portion 20b and the second power storage module 10B. The first space EP1 is a gap formed between the first power storage module 10A and the second power storage module 10B and the first side wall portion 20a. The second space EP2 is a gap formed between the first power storage module 10A and the second power storage module 10B and the second side wall portion 20b.

The third side wall portion 20c of LWR case 21 is provided with a case exhaust valve 211 at a position facing the first space EP1 and the second space EP2. The case exhaust valve 211a is provided at a position facing the first space EP1, and the case exhaust valve 211b is provided at a position facing the second space EP2. The case exhaust valve 211a corresponds to the “first case exhaust valve” of the present disclosure, and the case exhaust valve 211b corresponds to the “second case exhaust valve” of the present disclosure. The fourth side wall portion 20d is provided with a case exhaust valve 211 at a position facing the first space EP1 and the second space EP2. The case exhaust valve 211c is provided at a position facing the first space EP1, and the case exhaust valve 211d is provided at a position facing the second space EP2. The case exhaust valve 211c corresponds to the “third case exhaust valve” of the present disclosure, and the case exhaust valve 211d corresponds to the “fourth case exhaust valve” of the present disclosure.

Gases are discharged from the exhaust valve 111 of the power storage cell 100 included in the first power storage module 10A toward the third space EP3. Gases are discharged from the exhaust valve 111 included in the second power storage module 10B toward the fourth space EP4. These gases pass through the first space EP1, the second space EP2, the third space EP3, and the fourth space EP4, and are discharged from the case exhaust valve 211a to the outside of the housing case 20 from 211d, as indicated by the two-dot chain arrow. The gas discharged from the power storage cell 100 can be discharged to the outside of the housing case 20 without forming a large number of ventilation holes in the housing case 20.

The case exhaust valve 211a, 211b is provided at a position facing each of the first space EP1 and the second space EP2 in the third side wall portion 20c. The case exhaust valve 211c, 211d is provided at a position facing each of the first space EP1 and the second space EP2 in the fourth side wall portion 20d. Accordingly, the gases flowing through the first space EP1 and the second space EP2 can be efficiently discharged from the case exhaust valve 211a to the outside of the housing case 20 from 211d.

### Embodiment 2

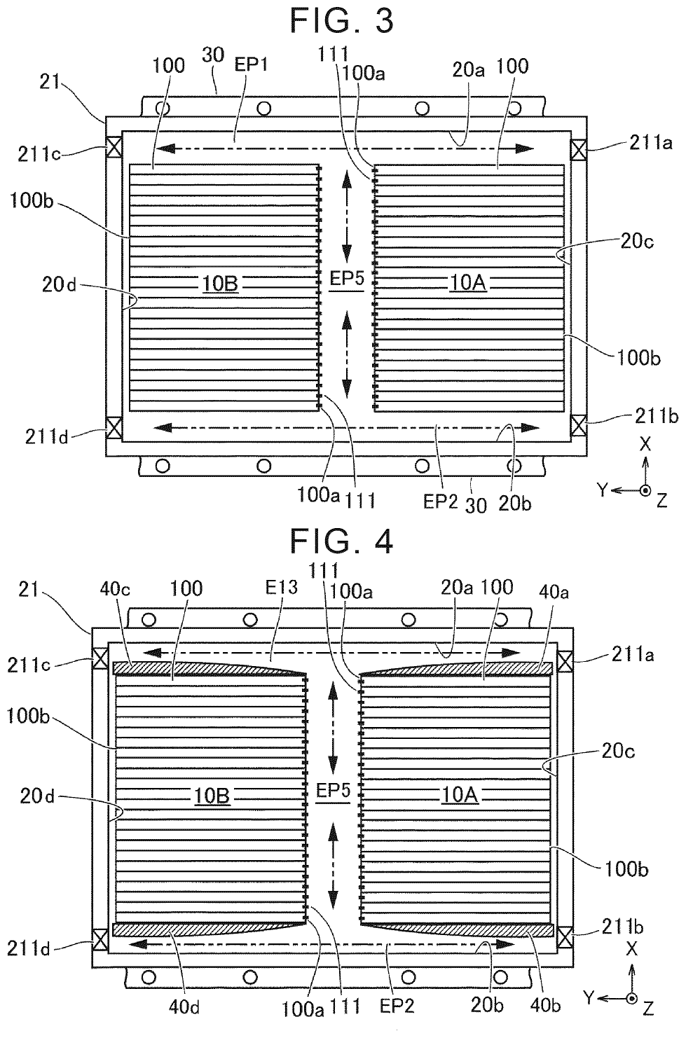

FIG. 3 is a plan view of a power storage device according to Embodiment 2. In the second embodiment, the configuration of the housing case 20 is the same as that of the first embodiment. In FIG. 3, UPR case 22 is omitted.

The second embodiment differs from the first embodiment in the direction of Y in the first power storage module 10A and the second power storage module 10B. In the first power storage module 10A, the second end face 100b of the power storage cell 100 is disposed to face the third side wall portion 20c. In the second power storage module 10B, the second end face 100b of the power storage cell 100 is disposed to face the fourth side wall portion 20d. Then, the first end face 100a of the power storage cell 100 of the first power storage module 10A and the first end face 100a of the power storage cell 100 of the second power storage module 10B are disposed to face each other, and a fifth space EP5 between the first power storage module 10A and the second power storage module 10B is formed. The exhaust valve 111 of the power storage cell 100 of the first power storage module 10A and the second power storage module 10B faces the fifth space EP5. The fifth space EP5 is connected to the first space EP1 and the second space EP2.

According to the second embodiment, the gases are discharged from the exhaust valves 111 of the power storage cells 100 of the first power storage module 10A and the second power storage module 10B toward the fifth space EP5. The gases discharged to the fifth space EP5 pass through the first space EP1 and the second space EP2, and are discharged from the case exhaust valve 211a to the outside of the housing case 20 through 211d. The gas discharged from the power storage cell 100 can be discharged to the outside of the housing case 20 without forming a large number of ventilation holes in the housing case 20. The gases flowing through the first space EP1 and the second space EP2 can be efficiently discharged from the case exhaust valve 211a to the outside of the housing case 20 from 211d disposed at a position opposed to the first space EP1 or the second space EP2.

### Embodiment 3

FIG. 4 is a plan view of a power storage device according to Embodiment 3. In the third embodiment, the configuration of the housing case 20 is the same as that of the first embodiment. In FIG. 4, UPR case 22 is omitted.

In the third embodiment, in the configuration of the second embodiment, the guide member 40 for guiding the gas discharged from the power storage cell 100 to the case exhaust valve 211 is provided. In the first space EP1, a guide member 40a and a guide member 40c are provided. The guide member 40a is disposed adjacently to the first power storage module 10A, and guides the gases from the center of the first space EP1 in the Y direction (the connecting portion between the first space EP1 and the fifth space EP5) toward the case exhaust valve 211a. The guide member 40a is disposed adjacently to the first power storage module 10A from the end portion in the +Y direction of the first power storage module 10A toward −Y direction (the direction of the case exhaust valve 211a), so that the passage cross-sectional area of the first space EP1 gradually decreases. As a result, the gases flowing through the first space EP1 are smoothly guided to the case exhaust valve 211a without staying.

The guide member 40c is disposed adjacently to the second power storage module 10B, and guides the gases from the center of the first space EP1 in the Y direction (the connecting portion between the first space EP1 and the fifth space EP5) toward the case exhaust valve 211c. The guide member 40c is disposed adjacently to the second power storage module 10B from −Y end of the second power storage module 10B in the +Y direction (the direction of the case exhaust valve 211c) so that the passage cross-sectional area of the first space EP1 gradually decreases. As a result, the gases flowing through the first space EP1 are smoothly guided to the case exhaust valve 211c without staying.

In the second space EP2, a guide member 40b and a guide member 40d are provided. The guide member 40b is disposed adjacent to the first power storage module 10A, and the guide member 40d is disposed adjacent to the second power storage module 10B. The guide member 40b, 40d has a configuration similar to that of the guide member 40a, 40c, and the gases flowing in the second space EP2 are smoothly guided to the case exhaust valve 211b, 211d without staying.

In the embodiment shown in FIG. 4, the passage cross-sectional area of the first space EP1 or the second space EP2 is gradually decreased from the case exhaust valve 211a toward 211d, and the length (width) in the X direction from the guide member 40a to 40d is increased from the case exhaust valve 211a toward 211d. However, the length (height) of 40d from the guide member 40a in the Z direction may be increased from the case exhaust valve 211a toward 211d. The passage cross-sectional area of the first space EP1 or the second space EP2 may be gradually decreased from the case exhaust valve 211a toward 211d. The gases flowing through the first space EP1 and the second space EP2 may be smoothly guided from the case exhaust valve 211a to 211d without staying. Note that the guide member 40a and the guide member 40c correspond to the “first guide member” of the present disclosure, and the guide member 40b and the guide member 40d correspond to the “second guide member” of the present disclosure.

### Embodiment 4

FIG. 5 is a plan view of a power storage device according to Embodiment 4. In the fourth embodiment, the configuration of the housing case 20 is substantially the same as that of the first embodiment. In FIG. 5, UPR case 22 is omitted.

In Embodiment 4, the first power storage module 10C and the second power storage module 10D are stacked in the X direction such that the first end face 100a and the second end face 100b of the adjacent power storage cells 100 are alternately arranged in the Y direction. In the first power storage module 10C and the second power storage module 10D, the external terminals 112 and 113 of the adjacent power storage cells 100 are connected by busbars. In the fourth embodiment, the plurality of power storage cells 100 are electrically connected in series in the first power storage module 10C and the second power storage module 10D.

The first power storage module 10C is arranged such that a third space EP3 is formed between the first power storage module and the third side wall portion 20c. The exhaust valve 111 of some of the power storage cells 100 included in the first power storage module 10C faces the third space EP3. The second power storage module 10D is disposed such that a fourth space EP4 is formed between the fourth side wall portion 20d. The exhaust valve 111 of a part of the power storage cells 100 included in the second power storage module 10D faces the fourth space EP4. The first power storage module 10C and the second power storage module 10D are arranged so that a fifth space EP5 is formed between the first power storage module 10C and the second power storage module 10D. The exhaust valves 111 of some of the power storage cells 100 included in the first power storage module 10C and the second power storage module 10D face the fifth space EP5.

A first space EP1 is formed between the first side wall portion 20a of LWR case 21 and the first power storage module 10C and between the first side wall portion 20a and the second power storage module 10D. A second space EP2 is formed between the second side wall portion 20b of LWR case 21 and the first power storage module 10C and between the second side wall portion 20b and the second power storage module 10D. The first space EP1 is a gap formed between the first power storage module 10C and the second power storage module 10D and the first side wall portion 20a. The second space EP2 is a gap formed between the first power storage module 10C and the second power storage module 10D and the second side wall portion 20b.

The third side wall portion 20c of LWR case 21 is provided with a case exhaust valve 211a, 211b as in the first embodiment. The fourth side wall portion 20d is provided with a case exhaust valve 211c, 211d as in the first embodiment.

Gases are discharged from the exhaust valve 111 of the power storage cell 100 included in the first power storage module 10C and the second power storage module 10D toward the third space EP3, the fourth space EP4, and the fifth space EP5. These gases pass through the first space EP1 and the second space EP2 and are discharged from the case exhaust valve 211a to the outside of the housing case 20 from 211d as indicated by the double-dot chain arrow. The gas discharged from the power storage cell 100 can be discharged to the outside of the housing case 20 without forming a large number of ventilation holes in the housing case 20.

As in the first embodiment, the case exhaust valve 211a, 211b is provided at a position facing each of the first space EP1 and the second space EP2 in the third side wall portion 20c. The case exhaust valve 211c, 211d is provided at a position facing each of the first space EP1 and the second space EP2 in the fourth side wall portion 20d. Accordingly, the gases flowing through the first space EP1 and the second space EP2 can be efficiently discharged from the case exhaust valve 211a to the outside of the housing case 20 from 211d.

### Embodiment 5

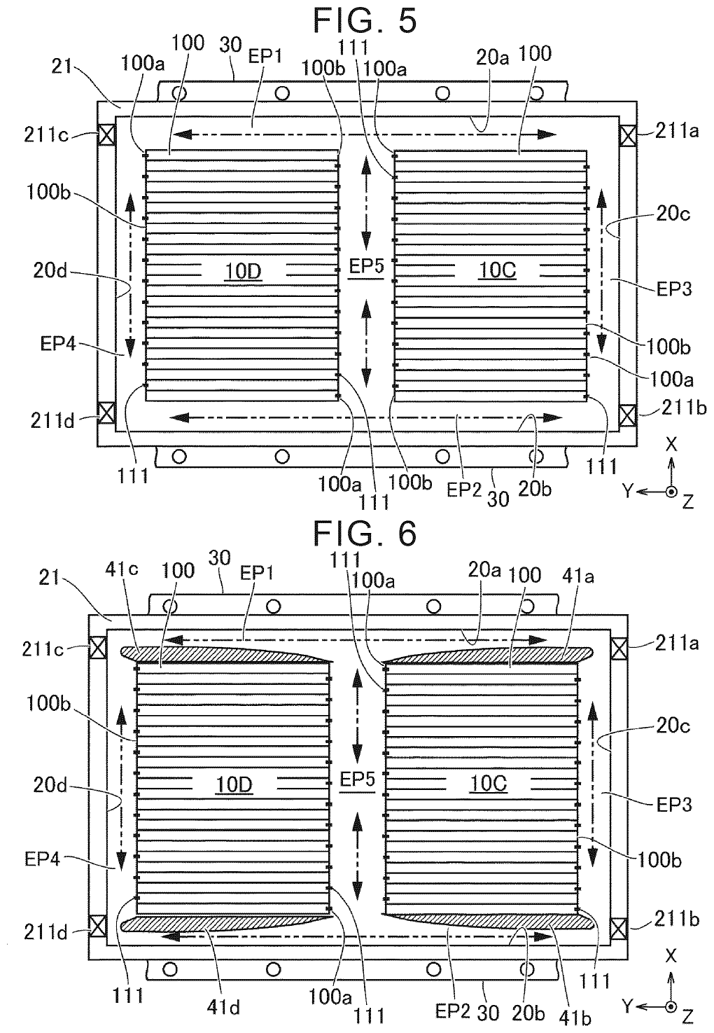

FIG. 6 is a plan view of a power storage device according to Embodiment 5. In the fifth embodiment, the configuration of the housing case 20 is the same as that of the fourth embodiment. In FIG. 6, UPR case 22 is omitted.

In the fifth embodiment, in the configuration of the fourth embodiment, the guide member 41 is provided to guide the gas discharged from the power storage cell 100 to the case exhaust valve 211. In the first space EP1, a guide member 41a and a guide member 41c are provided. The guide member 41a is disposed adjacently to the first power storage module 10C, and guides the gases from the center of the first space EP1 in the Y direction (the connecting portion between the first space EP1 and the fifth space EP5) toward the case exhaust valve 211a. The guide member 41a is disposed adjacently to the first power storage module 10A so that the passage cross-sectional area of the first space EP1 gradually decreases from the end portion of the first power storage module 10C in the +Y direction toward −Y direction (the direction of the case exhaust valve 211a). Further, the guide member 41a includes a guide portion that guides the gases flowing in the third space EP3 from the +X direction end portion of the first power storage module 10C toward the case exhaust valve 211a. Accordingly, the gases flowing through the first space EP1 and the third space EP3 are smoothly guided to the case exhaust valve 211a without staying.

The guide member 41c is disposed adjacently to the second power storage module 10D, and guides the gases from the center of the first space EP1 in the Y direction (the connecting portion between the first space EP1 and the fifth space EP5) toward the case exhaust valve 211c. The guide member 41c is disposed adjacently to the second power storage module 10B so that the passage cross-sectional area of the first space EP1 gradually decreases from −Y end portion of the second power storage module 10D toward the +Y direction (the direction of the case exhaust valve 211c). Further, the guide member 41b includes a guide portion that guides the gases flowing in the fourth space EP4 from the +X direction end portion of the second power storage module 10D toward the case exhaust valve 211c. Accordingly, the gases flowing through the first space EP1 and the fourth space EP4 are smoothly guided to the case exhaust valve 211c without staying.

In the second space EP2, a guide member 41b and a guide member 41d are provided. The guide member 41b is disposed adjacent to the first power storage module 10C, and the guide member 41d is disposed adjacent to the second power storage module 10D. The guide member 41b, 41d has a configuration similar to that of the guide member 41a, 41c, and the gases flowing in the second space EP2, the third space EP3, and the fourth space EP4 are smoothly guided to the case exhaust valve 211b, 211d without staying.

In the embodiment shown in FIG. 5, the passage cross-sectional area of the first space EP1 or the second space EP2 gradually decreases from the case exhaust valve 211a toward 211d, and the length (width) in the X direction from the guide member 41a to 41d increases from the case exhaust valve 211a toward 211d. However, the length (height) of 41d from the guide member 41a in the Z direction may be increased from the case exhaust valve 211a toward 211d. The passage cross-sectional area may be gradually reduced from the case exhaust valve 211a toward 211d. Gases flowing through the first space EP1, the second space EP2, the third space EP3, and the fourth space EP4 may be smoothly guided from the case exhaust valve 211a to 211d without staying.

In each of the above-described embodiments, in addition to the first power storage module and the second power storage module, other components may be housed in the housing case 20. The other components may be, for example, a cooling plate, a battery monitoring device, a battery control device, or the like.

The embodiment disclosed this time should be considered to be illustrative in all respects and not restrictive. It is intended that the scope of the disclosure be defined by the appended claims rather than the description of the embodiments described above, and that all changes within the meaning and range of equivalency of the claims be embraced therein.

What is claimed is:

1. A power storage device comprising:
a first power storage module including a plurality of first power storage cells;
a second power storage module including a plurality of second power storage cells; and
a housing case that houses the first power storage module and the second power storage module, wherein
the first power storage module and the second power storage module are disposed in a first direction,
the housing case includes a first side wall portion located on one side in a second direction orthogonal to the first direction, and a second side wall portion located on the other side in the second direction,
a first space is defined between each of the first power storage module and the second power storage module and the first side wall portion,
a second space is defined between each of the first power storage module and the second power storage module and the second side wall portion, and
the housing case includes a case exhaust valve that discharges gas discharged from at least one of the first power storage cells and the second power storage cells to an outside of the housing case.

2. The power storage device according to claim 1, wherein:
the housing case further includes a third side wall portion located on one side in the first direction, and a fourth side wall portion located on the other side in the first direction; and
the case exhaust valve includes:
a first case exhaust valve and a second case exhaust valve provided in the third side wall portion at positions where the first case exhaust valve and the second case exhaust valve face the first space and the second space, respectively; and
a third case exhaust valve and a fourth case exhaust valve provided in the fourth side wall portion at positions where the third case exhaust valve and the fourth case exhaust valve face the first space and the second space, respectively.

3. The power storage device according to claim 2, wherein:
the first power storage cells are arranged in the second direction;
the second power storage cells are arranged in the second direction;
at least one of the first power storage cells includes an exhaust valve that discharges gas toward the second power storage module;
at least one of the second power storage cells includes an exhaust valve that discharges gas toward the first power storage module;
first guide members that guide the gas from a central side in the first direction toward the first case exhaust valve and the third case exhaust valve are disposed in the first space to adjoin the first power storage module and the second power storage module; and
second guide members that guide the gas from the central side in the first direction toward the second case exhaust valve and the fourth case exhaust valve are disposed in the second space to adjoin the first power storage module and the second power storage module.
